(19) United States
(12) Patent Application Publication
(10) Pub. No.: US 2008/0271559 A1
(43) Pub. Date: Nov. 6, 2008

(54) Turn-actuator with tensile element of shape memory alloy

(75) Inventors: Markus Garscha, Weissenburg (DE); Helmut Auernhammer, Hottingen (DE); Klaus Engelhardt, Weissenburg (DE)

Correspondence Address: DORITY & MANNING, P.A., POST OFFICE BOX 1449, GREENVILLE, SC, 29602-1449, US

(73) Assignee: Alfmeier Prazision AG Baugruppen und Systemlosungen

(21) Appl. No.: 11/503,392

(22) Filed: Aug. 10, 2006

(30) Foreign Application Priority Data
Aug. 11, 2005 (DE) 10 2005 038 330.0
Dec. 10, 2005 (DE) 10 2005 059 081.0
May 29, 2006 (DE) 10 2006 025 202.0

(51) Int. Cl. G05G 1/00

(52) U.S. Cl. 74/469

(57) ABSTRACT

A turn-actuator possesses a rotatably placed driven element, which turns about an axis of rotation and has at least a first and a second tensile element of a shape memory alloy. The first and second tensile elements are affixed to the driven element, whereby the directions of rotation from torques generated by the contractions of the first and the second tensile elements act upon the driven element in opposite directions.

### FIELD OF THE INVENTION

The invention concerns a turn-actuator with a tensile element of a shape memory alloy.

### BACKGROUND OF THE INVENTION

The use of shape memory alloys, especially in wire form, is continually gaining strength in actuator technology, since such alloys can be economically employed to create tension very simply and do this at low cost while offering the advantage of flexibility. If a wire of a Shape Memory Alloy (also referred to herein as SMA) is subjected to a current of electricity, then its temperature begins to climb due to its internal resistance. Upon a departure from a predetermined threshold temperature, which is also known as a start temperature, a structure change of the alloy begins and the metal deforms itself relative to the length of the wire, that is to say, it contracts. The wire thereby produces a tensile force.

If no further energy, such as heat, is applied, then the temperature of the wire declines because of heat exchange with the ambient surroundings. Again, if no external tensile forces are applied thereto, the wire retains its shortened length. The wire can, however, be stretched to its original length by, for example, a spring. The force required for returning to the original, basic shape, as in the cooled condition, in this operation, is smaller than the tensile force developed by the wire in its heated condition. Because of the contraction of length of the wire upon the heating thereof, shape memory alloys, when so drawn into wires, are employed, as a rule, as a producer of linear force, namely a tensile force.

For example, US 2004/0112049 A1 discloses the making of a bidirectional turning actuator with the aid of a SMA-wire, a pulley and a retraction spring. This turning actuator does not exert a linear force on a driven element, for instance, on a shaft, i.e., produce a linear displacement thereon, but instead, exerts a turning movement on the driven element. The SMA-wire, however, undergoes in this operation its own linear contraction motion as before, which, however, is converted into a torque through lever action on the shaft. In this way the SMA-wire rotates the shaft, i.e. the actuator, in a predetermined direction. By means of a corresponding retraction spring, which produces a counter torque, the turn-actuator rotates in the opposite direction when, as described above, the temperature of the wire drops, and the spring force assumes that function formerly supplied by the wire.

In the case of known SMA-type turn-actuator, it is possible, by continual shortening of the SMA-wire, to maintain a constant positioning, that is to say, one can achieve, or develop a desired angular setting of the shaft. In order to obtain a desired angular position of the turn-actuator, it is necessary that electric current be constantly supplied to the SMA-wire, in order to produce the temperature for structural deformation in the wire and to maintain its shortening of by a calculated length. Once the current is shut off, then the wire cools and the retraction of the spring arrangement draws the wire once again into its original length, which, correspondingly, is carried out by a back rotation of the shaft into its starting position. The rotational position of the shaft will also determine the torque, i.e. the compensation of force of SMA-wire, retraction spring and an external source of turning moment. In the case of an interruption of the supply of energy, for example, a failure of the current, a possibly undesirable retropositioning of the actuator can occur.

### SUMMARY OF THE DISCLOSURE

The invention is directed to an improved bidirectional turn-actuator on the basis of shape memory alloys.

This purpose is achieved by a turn-actuator with a driven element which is carried in bearings in such a manner that it can rotate about its central axis. The turn-actuator contains a first and a second tensile element, each being a shape memory alloy. As a rule, the tensile elements are one and the same SMA, although, this identical conformation is not entirely necessary. These tensile elements, because of their contraction due to warming and inherent SMA properties, each activate a tensile force on the driven element. Since the driven element is turnably mounted, then each tensile force accordingly subjects it to a torque. The first and the second tensile element, in this action, are force-fit with the driven element in such a manner, that each, in regard to its own contraction produces, as stated, a torque on the driven element in relation to the axis of rotation. As this operation is carried out, however, the torques generated by the two tensile elements can produce counter directional forces, if the tensile elements respectively oppose one another.

Obviously, it is possible that a plurality of tensile elements can be provided, wherein some of these tensile elements rotate the driven element in one direction, and the remaining tensile elements would rotate the driven element in the opposite direction. However, at least one tensile element is necessary to provide, respectively, a component force for each of the two directions of rotation. A greater number of tensile elements need not, in this operation, be rotatingly attached at the identical place of the driven element. The driven element can be a roll, a lever or any other desired element.

Each of the first and second tensile elements can also be made as a one-piece SMA-element, such as an SMA-wire, each of which, for example, possesses on the ends as well as at approximately at a middle section, a total of three electrical contacts. In the area of the middle contact, the SMA-wire is, for example, wrapped about a turnaround pulley which also serves as the electrical contact. Both sections of the SMA-wire departing from the driven element, now have the possibility of being separated from one another between this middle contact and the respective wire ends and at the same time, each can be subjected to electrical current. When the current is applied, each end of the SMA-wire is heated and is of the opposite electrical pole. The one-piece SMA-wire forms, in this way, two, separate tensile elements which are individually controllable.

As has already been mentioned, one tensile element can only cause movement in one direction, namely in the direction of contraction, in accord with the property of a functioning activator. By means of the invented measure, namely, the provision of two tensile elements in the turn-actuator, which, in the case of their separate contractions, can produce counter acting torques on the driven element. This, however, enables the driven element to be moved by a single contraction of one or the other tensile element in either direction of rotation. Both directions of rotation of the turn-activator are thus enabled by means of torque, or, by example, the force generation of an SMA source, i.e., of a tensile element. This arrangement has the result that a reset element, for example in the form of a spring, which turns back the direction of rotation of a single tensile element, becomes superfluous. In other words, the resetting means as known in the state of the technology is replaced by the SMA-element.

A further advantage arises, in that if no current be applied, i.e., the heating of the tensile element in this manner is dispensed with; neither of the elements develops tension. Thus, the tensile elements do not need to experience any resetting force such as, for example, is required in the state of the technology. The tensile elements retain their heat-established length without aid. The driven element remains, thus, in its corresponding rotary position without retroacting itself to its original state on its own or by means of spring action. This is true as long as no foreign torque acts upon the turn-actuator from the outside to the extent that the resetting force of the tensile force is overcome. For the maintenance of an established, that is to say, a once accomplished rotational position, it is necessary, in opposition to the state of the technology that the tensile element not be subjected to current. This has the fortunate result that the turn-actuator operates essentially economically in regard to electrical current.

Beyond this, in the case of the invented turn-actuator the possibility exists, that with a simultaneous supply of current and a thereby resulting force created through both tensile elements at the same time, two opposite torques are produced on the driven element. In this way, there arises a holding torque of the driven element, which works externally and counters in direction to external forces to which the driven element might be subjected. That is to say, acts counter to the torques. Further, the turn-actuator resists also external force which may act upon it, that is, the turn-actuator resists a torque working against it and remains in its given rotational position. The holding torque is thus plainly greater than the above mentioned resetting torque in the no-current situation.

Otherwise, it may be desirable to achieve a certain degree of freedom for the turn-actuator. For this purpose, neither of the two tensile elements are electrically connected, on which account, an external displacement of the driven element is carried out, which displacement is principally counter to the resetting torque of the extendable tensile elements. If this is small enough, then the driven element can be externally displaced within the limits permitted by the tensile elements. In this case, the turn-actuator generates principally a known force thereagainst, namely a known restoration force of the SMA-elements. Thus, the turn-actuator itself exhibits, in a no-current situation of the tensile elements, a behavior similar to an integrated slip-clutch.

For the obtaining of a rotational movement of the driven element, as a rule current is supplied only to one or more driven tensile elements acting in the same rotational direction on the driven element. This then brings about by contraction the desired rotational movement which will also be in the desired direction. Since the contraction of the tensile element within a given temperature range remains constant, it is possible that by means of the heating temperature the contraction and therewith the rotational position of the driven element, i.e., the value of the torque created by driven element, can be determined. The heating temperature of the tensile element is determined here by means of the number thereof at the feed of electrical energy, for example, the current strength in each of the tensile elements.

As stated, the tensile elements of SMA are heated by the flow of internal current. At the same time, the first and the second tensile element are separated from one another by insulation. In this way, each tensile element can be subjected to a different strength of current if differently heated, which allows the development of correspondingly different tensile forces. In this way, a plurality of combinations exist for heating and therewith contraction. Consequently, gaining the advantage of torque application on the driven element becomes possible.

The respectively active, that is, heated, tensile element, which produces a contraction force, generally overcomes in this case, for example, as seen from the viewpoint of the above mentioned holding torque, simultaneously the expansion force of the other non-electrified, counter running tensile elements and extends these to the corresponding, necessary length, in order that the appropriate rotational position of the driven element can be attained.

Since the tensile elements, upon their contraction, produce a tensile force on the driven element, the driven element is subjected to two forces, respectively, from the first and the second tensile elements in known amounts and directions. These two forces can have a common resultant of direction. That is to say, they enclose an angle between them of less than 180°.

Thus, a force component acts upon the driven element by means of the two tensile elements, in the direction of the common resultant of direction. This force is engendered by both contraction and by the lengthening of the SMA-element, as well as by the retention of a force component on the driven element toward the common direction components. This opens the gate for many design possibilities, for example, in connection with a setting of a spring, exerting force counter to the said directional resultant, and the like. Some of these possibilities will be further described in greater detail below.

Specifically, is possible that the first and the second tensile element are placed parallel to one another. The forces exercised on the driven element by the tensile elements then possess, in common, directional components in the same direction. The common directional component of the two forces is, in this case, also the single directional component of the sum of the forces. The parallel arrangement of the tensile elements permits an especially space saving installation of the turn-actuator. Forces on the driven element vertically aligned to the common direction of force must not be picked up by the arrangement.

The driven element can be prestressed by spring action against the common directional component of the forces, to which it is being subjected. In such an installation of a spring, either the driven element or the tensile element immediately offers the advantage, that in accord with the setting of the prestressed spring, it is not absolutely certain in the turn-actuator that, first, upon the contraction of one tensile element, the other tensile element need be extended, or second, the spring-based effect of the driven element takes over the corresponding compensation of length.

Alternatively, or additionally, it is possible, as mentioned, to lift the driven element from a stationary bearing by means of the spring-based prestressing, providing force is exerted on the driven element by the tensile element and it is moved in a direction contrary to its spring-based prestressing. Upon the cooling of the tensile element and thus a relaxing of the tension produced thereby, the spring-based prestressing forces the driven element once again against an impact moderating brake abutment. The turn-actuator itself can also possess a moderating brake abutment, which will coact with it. In this way, it is also possible that the moderating brake abutment can be operated counter to the driven element. By means of the moderating brake abutment coacting with the driven element, it is possible that an independent holding brake, that is to say, a kind of a slip-clutch can be imposed on the driven element. This arrangement would either hold the driven element motionless or retain it in a rotational positioning up to the action of a predetermined outside force, which would be externally imposed upon the driven element.

For example, besides the possibility of allowing the moderating brake abutment or the driven element, by means of the above mentioned spring arrangement or motor drive to be forced upon one another or being forced apart, it is possible that the turn-actuator have a third tensile element acting on the moderating brake abutment and/or the driven element. The entire turn-actuator possesses, for this operation, essentially tension elements for the production of forces and requires acting upon the moderating brake abutment—in relation to the driven element—no other alternative for the generation of force. Naturally, as a rule, the favorable result is to release the moderating brake abutment before a displacement of the actuator is attempted.

The turn-actuator can have a housing wherein the axle is rigidly secured. As mentioned, this is a favorable solution for, e.g., a movable moderating brake abutment, or e.g., for that particular operational principal of the turn-actuator by which a contraction of one tensile element calls for the extension of the other.

As an alternative to this, the rotational axle can be installed in the housing to be movable in an axially vertical alignment. This variant would already have been mentioned in connection with the moderating brake abutment affixed to the housing, regarding which, for example, the driven element is lifted by contraction of one of the tensile elements. Further, this construction alternate, for example, is advantageous for the spring-based installation of the driven element.

From the combination of already mentioned measures, a turn-actuator can be created with first and second tensile elements running parallel to one another and which tensile elements also respectively produce forces on the driven element in the same direction. The driven element is installed parallel to the tensile elements and is slidingly movable in the housing according to the common directional resultant of the forces produced by the parallel tensile elements. Further, a spring element abuts itself between the driven element and the housing and exerts its force counter to the tension of the tensile element and is prestressed by spring force against a moderating abutment secured to the housing. The driven element is captured in the moderating brake abutment, which assures a holding torque. Upon the tension of one or both tensile elements, the spring element functions, and lifts the driven element away from the moderating abutment allowing its rotation. Upon a relaxation of the tension force, the driven element, forced by the spring, retracts again onto the moderating abutment.

The turn-actuator can possess a detent which borders that part of the angle of rotation range of the driven element. The tensile elements, in this case, are protected from excess extension caused by the action of a foreign force, i.e., by an outside torque on the driven element.

Frequently, turn-actuators are only put to use for the purpose of carrying out a positional change between angular settings, namely, end locations. In such a case, for turn-actuators there are only two different angular positionings, these being the end supports. The invented turn-actuator, however, can be so designed, that it possesses a stabilizing holding element, which retains the driven element at two alternative end positions. By means of the holding element, the turn-actuator is designed to be self-restricting, so that it is respectively stabilized by the holding element to dwell in the end positions, even when the SMA-element, i.e., the tensile element, is not electrically connected.

Converse to the above mentioned moderating brake abutment, which must be mechanically executed at the turn-actuator, or, more precisely, at the driven element, in order to be effective, a self-restricting mechanism has the advantage of self-stabilizing the turn-actuator itself in its respective end position to which it has last returned. To furnish the SMA-wires with current requires that, respectively, current must be brought in to effect the transition, i.e., the change of condition of the material, as well as the bringing of the driven element from the one to the alternative second end position.

The holding element can be a spring element which is relaxed in the end positions (or be of reduced tension) and in the area between the end positions, this can be a compressed spring (or be of greater compression). Away from, or out of, the respective end position, it is necessary that the turn-actuator, i.e., the driven element, must strive against the spring element, which assures the self-restricting function, i.e., the arresting of the driven element in the end positions. From the first to the second end position, the spring element becomes compressed until it reaches the dead point of maximum compression. Subsequently, the spring element gradually relieves itself at the second end position. Immediately after overcoming the dead point, it is possible to shut off the tensile element, that is, the current will no longer be furnished since the spring element sends the driven element to the alternative end position, namely by the relaxation of the spring element.

The spring element can have a position, with its first end on the driven element and with its second end stationarily fixed outside the mounted spring of the driven elements, whereby in a position of the driven element between the end locations, the axis of rotation of the driven element and the first and second ends of the spring all lie in a line. This situation is the above mentioned dead point, at which the spring element is at its maximum compression. The arrangement of the dead point position, that is to say, of the corresponding rotational angle of the driven element, can be either symmetrically set between the two end positions, or also asymmetrically chosen, in accord with the demands of the application. An appropriately installed, encompassing, spiral screw spring for resetting used as a spring element is particularly simple from the design standpoint and can be economically integrated into a turn-actuator and, due to its simplicity, shows itself as particularly rugged in service.

In order to protect the tensile element from overloading, provision has been made in an additional embodiment, namely, binding the tensile element to a spring element, whereby the force from its electrically activated contraction can be introduced into a stationary storage point, i.e., a spring, opposite the tensile element. In this way, it is possible that the spring elements can be so designed, that that they yield, i.e. expand or compress, upon the overstepping of a threshold force and by this means, a tearing of the tensile element due to overload can be prevented. A preferred and easily realized design provides, that the spring element directly or indirectly, becomes, first, bound to the end of a tensile element and, second, coacts with the point of support.

A particularly effective overload protection for a tensile element is achieved by a switch, which coacts with the spring element in such a way, that in the case of an overload due to compression, an expansion of the spring element energizes the switch and the current supply to the tensile element is interrupted. Besides assuring the mechanical protection of a tensile element, it is also possible for the present embodiment to be employed for the detection of an overload or of such a fault which would cause an overload in an operative component of the turn-actuator, for instance, a fault in an aeration valve. In a case of an interruption of the current feed to a tensile element it is possible that a warning signal is generated and thereby, the user be made aware of a disturbance. The above described overload protection need not be limited to a turn-actuator as described in this application, but is of value in general for all actuators or other apparatuses in which, for example, wire type tensile elements made of a shape memory alloy are installed.

The above and other aspects and advantages of the present disclosure are apparent from the detailed description below and in combination with the drawings in which:

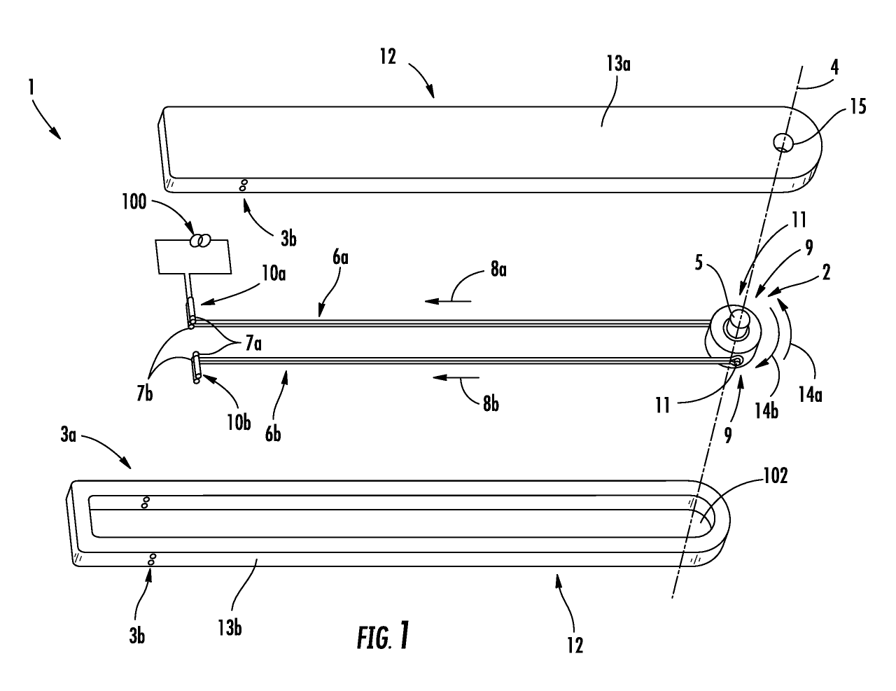

FIG. 1 is a turn-actuator with a rotatably secured positional element and two tensile elements in a perspective view;

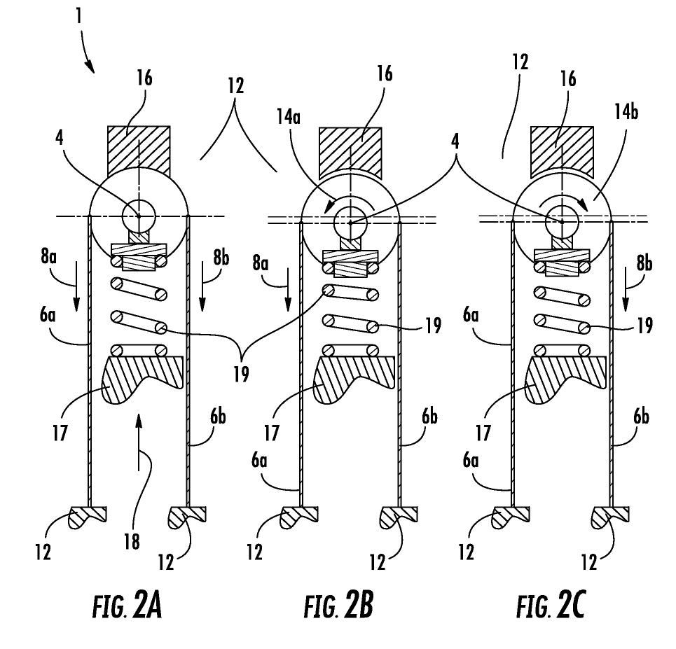

FIG. 2 is an alternative embodiment of a rotatably and slidably mounted turn-actuator with a housing affixed moderation abutment in three different operational positions a), b), and c) in cross-section;

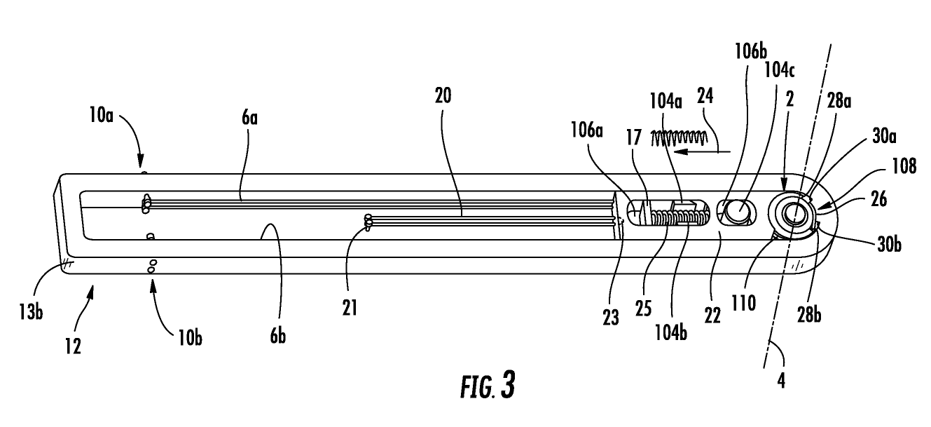

FIG. 3 is a turn-actuator in accord with FIG. 1 with a moderation brake abutment capable of being lifted from its setting by a third tensile element, shown in a perspective view;

FIGS. 4 & 5 is an embodiment, wherein a driven element of the turn-actuator is stabilized by a holding element at two end locations;

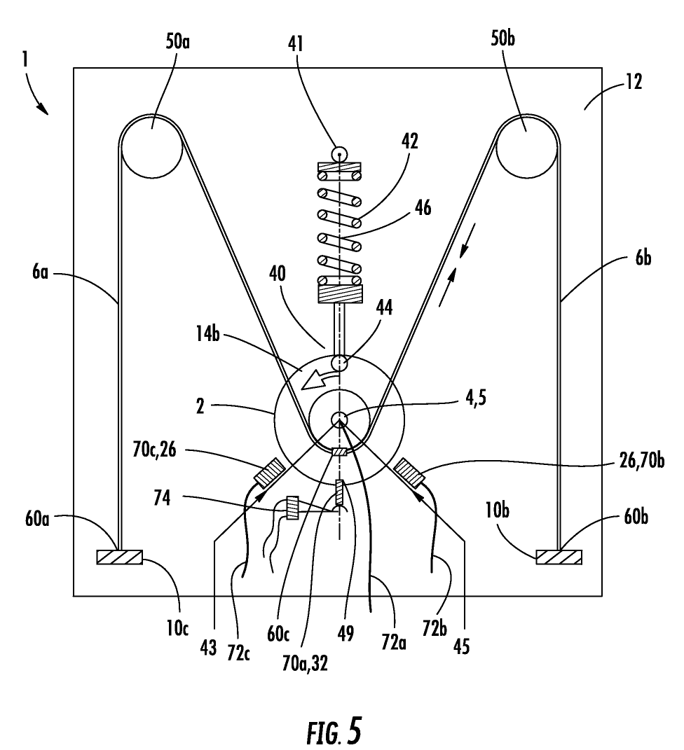

FIG. 6 a longitudinal section through an overload protection apparatus with the end of a therewith coacting tensile element in a first operational situation;

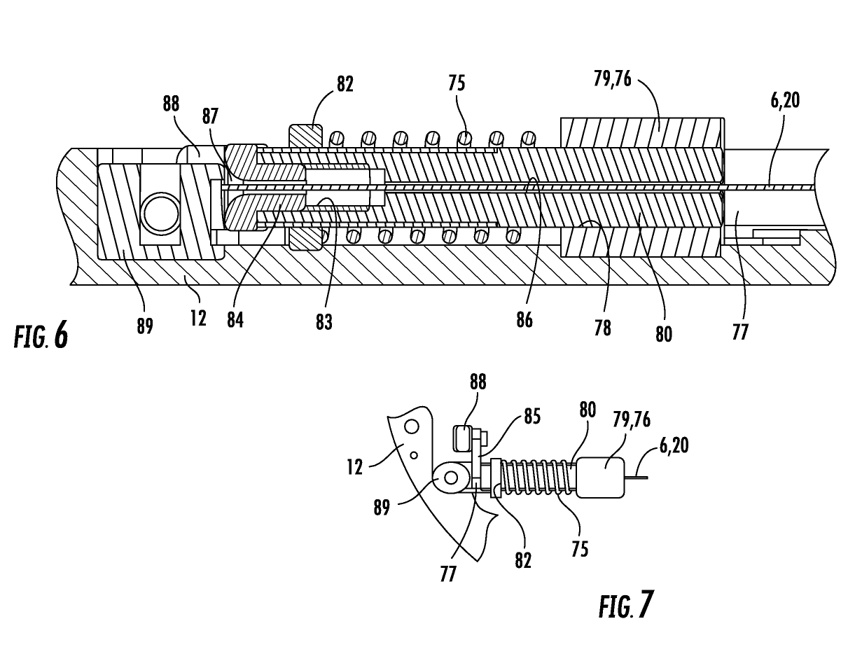

FIG. 7 a profile view of the equipment of FIG. 6;

FIG. 8 is an overload protection apparatus in a drawing based on FIG. 6, whereby the equipment finds itself in a second operational situation; and

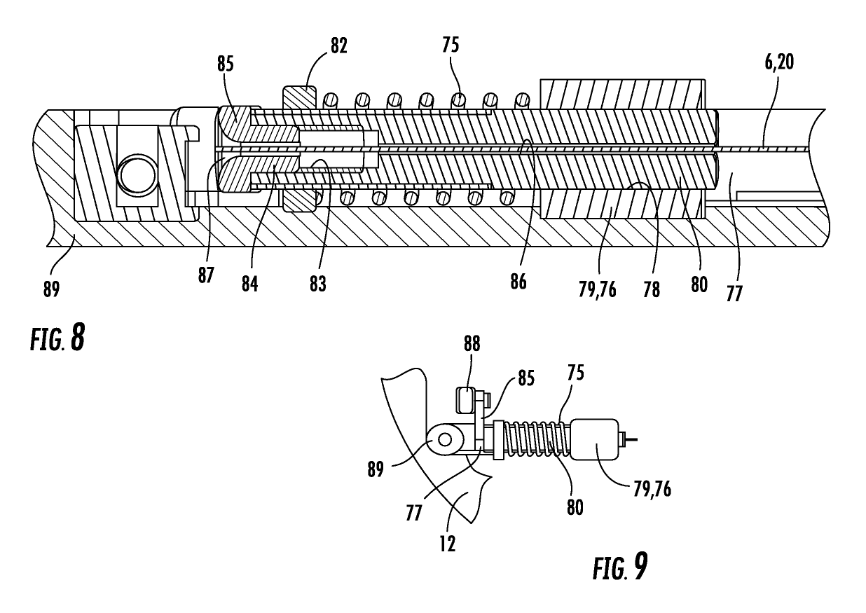

FIG. 9 is a profile view of the apparatus of FIG. 8.

### DETAILED DESCRIPTION OF THE DRAWINGS

Detailed reference will now be made to the drawings in which examples embodying the present invention are shown. The detailed description uses numerical and letter designations to refer to features in the drawings. Like or similar designations in the drawings and description have been used to refer to like or similar parts of the invention.

The drawings and detailed description provide a full and detailed written description of the invention and of the manner and process of making and using it, so as to enable one skilled in the pertinent art to make and use it, as well as the best mode of carrying out the invention. However, the examples set forth in the drawings and detailed description are provided by way of explanation of the invention and are not meant as limitations of the invention. The present invention thus includes any modifications and variations of the following examples as come within the scope of the appended claims and their equivalents.

FIG. 1 shows a turn-actuator 1 with a positioning element 2 and two SMA-elements 6a and 6b, which serve as tensile elements. The positioning element 2 operates within a housing 12, which housing 12 consists of an upper part 13a and an under part 13b. These parts controllingly rotate about an axis 4. An axle 5, aligned with the axis 4, protrudes from the end of the positioning element 2 and serves for the torque output therefrom relative to the housing 12. For this purpose, the driven axle 5 extends itself axially in an assembly of the turn-actuator 1 out of the upper part 13a, thereby protruding out of the opening 15. Simultaneously, opening 15 serves as an alignment guide for the axis 4 as a center of rotation for the driven element 2. The driven element 2 is held in axial alignment against the upper part 13a by the bearing surface 102 in the under part 13b.

The SMA-elements 6a and 6b are SMA-wires and run parallel to one another. The two respective wire ends 7a and 7b of each SMA-element 6a, 6b are respectively fastened on the housing 12 by holders 10a, 10b which serve also as electrical, current supply conductors. In this respect, the holders 10a, 10b are fitted into a plurality of borings 3a, 3b of the housing 12. The supply of electrical current is symbolically indicated for the SMA-element 6a by means of the electrical circuit 100.

Approximately in the middle, between the ends 7a and 7b, is to be found each SMA-element 6a, 6b which is schematically shown here as a wire and which is held in the shape of a loop 9 wrapped about the pins 11 of the of the positioning element 2.

The two SMA-elements 6a, 6b are insulated, one from the other and hence can be separately provided with electrical current from respectively one end 7a to the other end 7b, with the result that they can be individually heated or cooled.

Upon the flow of electrical current therethrough, the SMA-elements 6a, 6b become heated, and thereby, shorten themselves. The loops 9 of the respective SMA-elements 6a, 6b now circumferentially move themselves on this account against the holders 10a, 10b which are affixed to the housing. The positioning element 2 is then subjected by the pins 11 by a force in the direction of arrows 8a, 8b and element 2 turns itself subsequently about the axis 4 in the direction of either of the arrows 14a, 14b.

Giving consideration to the effect of their contraction, the SMA-elements 6a, 6b are oppositely placed in relation to the positioning element 2. Both SMA-elements also effect a counter rotation of the positioning element 2 about the axis 4, when contracted. This is achieved by means of the pins 11 which lie diametrically opposite in relation to the positioning element 2. A contraction of the SMA element 6a in the direction of the arrow 8a shortens this. The corresponding loop 9 pulls in the same direction at the pin 11 of the positioning element 2 and activates the rotation thereof in the direction of the arrow 14a. Simultaneously, the SMA-element 6b is once again extended, counter to the direction of the arrow 8b against its own force, i.e., the force being the retraction force. Thus, by alternate heating of the two SMA-elements 6a, 6b the positioning element 2 can be pivoted in both directions 14a and 14b.

As rule, in order to achieve a turning motion, i.e. to produce a torque in positioning element 2, only one SMA-element 6a or 6b need be supplied with current. The contraction of the SMA-element 6a, 6b finds itself, in this situation, always within the allowable temperature window. Thus a determination may be made, by means of first, the heating temperature, second, the degree of the contraction effected of the position, that is, of the rotational angle of the positioning element 2, which in turn is also the degree of the torque which can be obtained therefrom. The heating temperature, in turn, is made known by the feed of electrical energy to the SMA-element 6a, 6b.

Both the adjustable angular range of the positioning element 2 as well as the torque which is generated therefrom, are dependent on the mechanical design of the positioning element 2 and the lever action of the positioning element 2 and the SMA-element 6a, 6b. Within this design are to be considered the various geometries, lengths of wires, ratios and the like, in order that, for each required positional angle, a corresponding, optimal torque at the driven axle 5 of the turn-actuator 1 can be obtained, which is adapted to a current application.

If a position determination is desired, that is, of the current angle of rotation of the positioning element 2, then this can be brought about in various ways, as shown in the following:

First, it is possible that the fact can be made use of, that the change of the length of the SMA-element 6a, 6b responds to its absolute electrical resistance. By the measuring of the resistance of the SMA resistance 6a between the electrical connections or holding devices 10a in the circuit 100, it is possible that the actual length of this can be determined and thus the rotational/actuator placement of the positioning element 2 may be calculated, since the geometric relationships of the turn-actuator 1 are already known.

Second, a direct angle measurement can be carried out on the positioning element 2. With recourse to a potentiometer, it is possible, for example, that a (not shown) resistance train can be established on the turn-around pulley shaped positioning element 2, whereby the resistance train, with the aid of a (not shown) stationary loop on the housing 12 can be contacted. The resistance measured over the loop is thus proportional to the angular position of the positioning element 2.

Third, it is possible, for example, by means of magnetizing the positioning element 2 or by means of the integration of a (not shown) magnet in the same, along with a (not shown) Hall-sensor to achieve a hysteresis-free, position measurement.

Further, foreign forces can be detected in the invented turn-actuator. This applies to external forces which act upon the positioning element 2 and to which the driven axle 5 is also subject. Should, for instance, a tension load be exerted on a SMA-element 6a, then its electrical resistance will change. This resistance change can be detected again by means of the connection clamps 10a. An operational use finds a measurement of this kind, for example, in the case of the recognition of a blocking of the positioning element 2 or of a protection of the entire turn-actuator 1 on the basis of overload.

In order to obtain a holding torque at a known rotational placement of the positioning element 2, several possibilities are available, for example:

First, it is possible both SMA-elements 6a, 6b can be simultaneously furnished with current, whereby both torques, which are contrary to one another, act upon the positioning element 2. Because of the equivalence of forces in a predetermined rotational placement, a holding torque results for the positioning element 2 against an external force, that is, an external torque.

Second, in accord with FIG. 2, an arresting action, that is, a slip-clutch action, by means of a moderating brake abutment 16 acting on the positioning element 2 can be achieved. In FIG. 2, the moderating brake abutment 16 stationarily rests and is affixed to the housing 12. The positioning element 2 is placed moveable to and from the moderating brake abutment 16 in the direction of the arrow 18. For this purpose, the axis of rotation 4 is movable relative to the housing 12 in a direction counter to that of the arrow 18. The positioning element 2 is thus in physical contact with the moderating brake abutment 16, this being in the direction of arrow 18, and is prestressed by a spring 19 which abuts itself on a support piece 17 of the housing 12 and at its free end, the spring 19 is in contact with the positioning element 2. The SMA element 6a, 6b produce, as in FIG. 1, linear forces in the direction of the arrow 8a, 8b. Thus, while compressing the spring 19, these move, at need, the positioning element 2 away from the moderating brake abutment 16.

FIG. 2a shows the turn-actuator at rest, that is, without tension loading by the SMA-elements 6a, 6b. The spring 19 overcomes the resetting force of the SMA-elements 6a, 6b and longitudinally extends these to the required length, in order to push the positioning element 2 in the direction of the arrow 18 and thus against the moderating brake abutment 16. In FIGS. 2b, 2c are, respectively, the SMA-element 6a, 6b when subjected to current and on this account, are retracted in the direction of the arrow 8a, 8b. Thus a rotation of the positioning element 2, respectively, to the left and right in the direction 14a, 14b is achieved. The compensation for the length during the contraction is done, in this arrangement, by means of the sliding of the axis 4 counter to the direction of the arrow 18. Simultaneously, therewith the positioning element 2 is lifted from the moderating brake abutment 16 and thus positioning element 2 becomes free in its mobility.

The lifting from the moderating brake abutment 16 is carried out, as seen in FIG. 2, by means of the coaction of the two SMA-elements 6a, 6b and the spring 19. In FIG. 3, conversely, besides this arrangement a third SMA-element 20 is put to use, which again, through a corresponding application of current and holder 21 which is fastened on the end face of housing 12. As in the case of the SMA-elements, a loop 23 penetrates at approximately half the length of the SMA-elements a slider 22. The slider 22 is guided in such a manner in a complementary open recess by housing (12) affixed pins 104a, 104b, 104c on the under part 13b of the housing 12, that it can move itself only in the direction of the arrow 24 or contrary thereto.

In FIG. 3, the slider 22 is employed as a moderating brake abutment for the positioning element 2 and is under load from a spring 25. The spring 25 abuts itself, in this case, against a lug 17, which is rigidly affixed to the housing and is in a cutout 106a of the slider 22, which slider 22 attaches to the free end of the spring 25. The slider 22 can travel in the direction of the arrow 24 relative to the housing 12 and is thus able to lift the positioning element 2 against the force of the spring 25.

By means of admission of current to the SMA-element, this element shortens itself, the loop 23 pulls the slider 22 in the direction of the arrow 24, and, accordingly, the slider 22 moves in this direction. The axis 4 of the positioning element 2, as seen in FIG. 1, is retained by the upper part 13a, which is not shown in FIG. 13. Therefore the slider 22 distances itself from the positioning element 2. Before a rotational movement of the positioning element 2 begins, energized by the two SMA-elements 6a, 6b, it is necessary that the third SMA-element 20 be controlled in such a manner, that the moderating brake abutment in the form of the slider 22 be released, so that the slider can move away from the positioning element 2 in the direction of the arrow 24.

This can also be carried out in an alternative manner, (which is not shown) if the SMA-wire is electrically connected with the electrically conducting slider 22 and at the same time the positioning element 2 is also electrically conducting. Then it will be possible to run an electrical current from the positioning element 2 through the slider 22 to the SMA-element and through the holder 21. This will only be charged with electricity when the slider 22 has made contact with the positioning element. The presence of an electrical current establishes such a condition of equilibrium that the slider 22 is so raised away from the positioning element 2 that this can turn. Positioning element 2 and slider 22 coact in the manner of an electrical switch.

A dimensioning of the SMA-wires 20, 6a, 6b, moreover, can cause an automatic lifting of the slider 22 before the SMA-wires 6a, 6b develop their tensile force. To accomplish this, the SMA wire 20 can be selected with a smaller diameter than the diameters of the SMA-wires 6a, 6b. If both elements are then subjected to the same current, for instance in series connection, then the smaller SMA-wire 20 heats itself more rapidly and contracts earlier than does the SMA-element 6a, 6b.

Contrary to the embodiment shown in FIG. 2, remote control is possible. This can be brought about if, in accord with FIG. 3, the turn-actuator 1 is placed in an “at rest” phase by withholding current from the SMA-element 6a, 6b. With the turn-actuator 1 now being idle, then, an external, foreign torque acts upon the positioning element 2. This is affected by the torque driven axle 5 (FIG. 1) acting within its operational range. When this is accomplished, the brake assembly as well as the slider 22 is freed from the positioning element 2.

A foreign displacement of this type has no influence on the placement of the actuator 1 relative to its electrical control. By the appropriate application of known currents into the SMA-elements 6a, 6b, the expected rotational position of the positioning element 2 will be assumed once again.

FIG. 3 shows also detent abutment 26 which is fastened, or molded on to the under part 13b of the housing 12. This abutment mechanically limits the angle of rotational movement of the positioning element 2 about the axis 4. This limitation is achieved by means of a changeable adjustment of the detent shoulders 28a, 28b of the positioning element 2 in travel relation to the end faces 30a, 30b of the detent 26 upon the rotation of the positioning element 2. The detent shoulders 28a, 28b are formed by a radial, inward-turned excision 108 (FIG. 3) on the circumferential surface 110 of the positioning element 2. The limitation of the rotational angular range protects, among other things, the SMA-elements 6a, 6b from excessive extension due to the action of an external force or torque onto the positioning element 2.

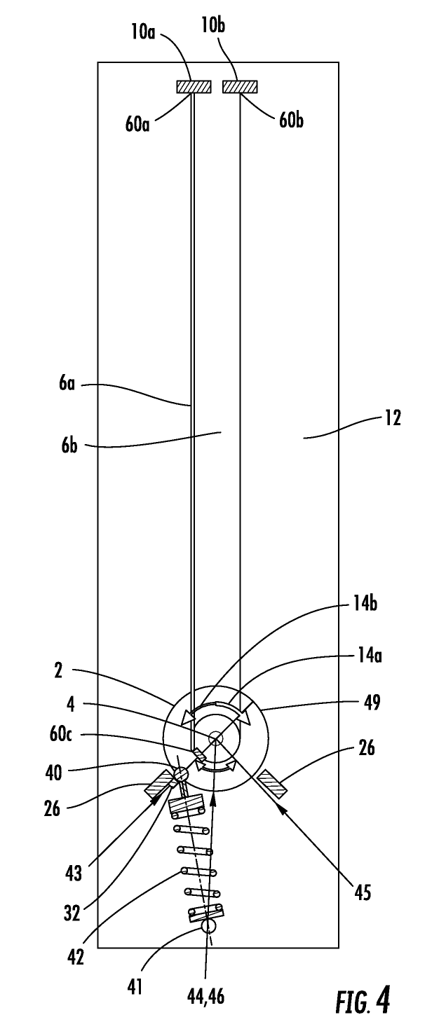

In FIGS. 4 and 5, are sketched two additional embodiments of the turn-actuator 1, in the case of which, the positioning element 2 is transposed to be between two end positions, in which location it can be affixed.

The FIGS. 4 and 5 further show, respectively, one turn-actuator 1 with two SMA-wires 6a, 6b, which can be supplied with electrical current by means of three current contacts 60a, 60b, 60c and one spring element, which, for example, is a positioning spring 42, which is of helical construction. The rotational angle range between the end-points 43, 45 of the positioning element 2 are determined as to location by the detent abutment 26 on the actuator housing 12 and a detent shoulder 32 of the positioning element 2, which shoulder coacts with the abutment 26 (not to be seen in FIG. 5). The positioning element 2 can accept either of two end supports, namely the end-points 43 and 45, in which the detent shoulder 32 lies against a detent abutment 26. The adjustment screw 42 is linkedly connected by its one end 40 onto the periphery of the positioning element 2 and with its other end 41 on the housing 12 of the turn-actuator. The end 40 is located, for example, on the angle bisector 46 of the rotational turning angle between the end-points 43, 45. The positioning spring 42 then exerts the same holding force on both end positions.

In the embodiment shown in FIG. 4, the positioning spring 42 is to be found on that side of the positioning element 2 which is remote from the SMA-wires 6a, 6b. Further, the positioning element 2, in the situation shown here, is in the left end position, thus at the end-point 43, wherein it is retained by the positioning spring 42. The detent shoulder 32 lies, in this instance, against the left detent abutment 26.

In order to bring the positioning element 2 into the right end point position 45, the right SMA-wire 6b is contracted due to application of current between the contacts 60b and 60c. Consequently, the sum of the torques acting upon the positioning element 2 plus the extending of the left SMA-wire 6a, as well as a linkup with the positioning element 2 counter to the action of the positioning spring 42 causes action in the direction of the arrow 14b to the right end position at the end-point 45. As soon as the bearing point at the end 40 of the position spring 42 oversteps a dead-point, then the torque of the position spring 42 likewise acts to create a rotation of the positioning element 2 in the direction of the arrow 14b toward the right end position at the end-point. The supply of current to the SMA-wire 6b can be ended at the latest, when the positioning element 2 has arrived at the right end-point 45 on which it will be held by the force of the position spring 42 without furnishing current to the SMA-wires 6a, 6b. By feeding current to the left wire 6a, between the contacts 60a and 60b, it is possible that the positioning element 2 can be retracted to the left end-point 43.

In an application of the illustrated turn-actuator 1, it is possible that the positioning element 2 can move, by the intervention of the force of the position spring 42, an apparatus (not shown), for instance a flap device, by means of a brief electrical connection of the SMA-element 6a, 6b, between two desired end positions and make a reliable fixation in either end position without the furnishing of electric energy.

FIG. 5 illustrates a turn-actuator 1 in comparison to that presented in FIG. 4, the SMA-elements 6a, 6b of which, however, have been run about the turn-around rolls 50a, 50b. In this way, it is possible to use long SMA elements with a correspondingly large contraction capability in spite of achieving a low height for an actuator. The position spring 42 is now located between the sections of the SMA-elements which run between the positioning element 2 and the turnaround rolls 50a, 50b. In the situation pictured, the end 40 for the fastening of the position spring 42 is found in the dead-point 44 and the position spring exercises no torque on the positioning element 2.

Alternative to the embodiments shown in FIGS. 4, 5, it is possible that the turn-actuator can be made with a (not shown) position spring, which is designed as a spiral tension spring. For this purpose, the end 40 of this position spring 42 is to be anchored on an oppositely lying point 49, which is diametrically opposite the fastening point of FIG. 4 or FIG. 5 on the periphery of the positioning element 2.

In FIG. 5, on point 49 is placed an electrical contact 70a in a circumferential location of the positioning element 2, which is electrically connected with feed line 72a. Further, the detent blocks 26 are designed as contacts 70b and 70c, which again, are provided with connection lines 72b and 72c. The contact 70a forms in this case, simultaneously the aforesaid detent shoulder 32 for impact against the detent block 26 in the respective end points 43 and 45. By means of the electrical feed lines 72a and 72c, the presence of the detent shoulder in contact 32 against the detent abutment 26 at the end-point 43 can be made obvious. In this matter, it becomes possible to allow a safety limit switch circuit of the turn-actuator 1, in order to electrically detect, that is to supervise, the secure and persistent attainment of the positioning element 2 at the end point 43. Correspondingly, the same is true for the feed connection lines 72a and 72b at the end point 45.

Additionally, it is also possible to electrically detect and supervise the time between the admission of current to the SMA-element 6a and the lifting of the detent shoulder 32 away from the detent abutment 26 in the end-point 45. This difference in time provides, for example, information about the ambient temperature of the turn-actuator 1, since this difference will play a role in the heating of the SMA-element from its current free condition to its contractive temperature.

Additionally to be found in FIG. 5, is an electric switch 74 with appropriate electrical connection lines, which is so mounted on the turn-actuator 1, that is to say, on the housing 12 thereof, that it is closed by the detent shoulder 32 during the turn action of the positioning element 2 at the dead-point 44, as shown in FIG. 5. In any other turn position of the positioning element 2 the switch 74 is open. By means of the switch 74, it becomes possible to supervise the passing of the dead-point 44 by the positioning element 2 upon its change between the end-points 43 and 45. Starting, for example, from end-point 43, the SMA-element 6b must first be supplied with current in order that it may work against the force of the position spring 42 as well as the contraction. If the dead-point 44 is, however, overstepped, which will be shown by the closing and subsequent opening of the switch 74, then the current flow through the SMA-element 6b can be again activated, since then the position spring 42 is already relaxed, which is to say, its spring force is made adequate in order to move the positioning element 2 additionally to the end-point 45 and to mechanically fix it in that location.

In general, it is possible for any actuator, in particular the turn-actuator of FIG. 5, to be so installed, that it can be activated both electrically, that is, by means of the SMA-elements 6a, 6b as well as manually, namely mechanically activated without supplying current to the SMA elements 6a, 6b and to exercise this force on the turn-actuator. Also, in this case, the detent abutments 26 serve as a limitation for the end positions of the turn-actuator 1. The fact that following a manual adjustment of the turn-actuator 1 to the two end-points 43 and 45, without electrically energizing the SMA-elements 6a, 6b, these two become elongated and thus at least one of them is no longer tensioned, in the situation presented in FIG. 5, for example, the SMA-element 6b, does not hinder this operation. The turn-actuator 1 is so designed, that even if both SMA-elements 6a, 6b are elongated at the same time, these can neither touch or hook or, for instance, impact themselves against the housing 12. As soon as, subsequently, at least one of the SMA-wires 6a, 6b is again electrified, an automatic tension occurs in both wires, as is described above.

The electric sensor in connection with the detent abutments 26, thus making use of the contacts 70b, 70c, is even advantageous for the manual adjustment of the turn-actuator 1. Thus it is possible, as described above, to reliably detect the respective location of the turn-actuator 1 in the end-points 43 or 45. Beyond this, in such a case, where none of the contacts 70b, 70c deliver a signal, the assumption may be made, that immediately an external manual activation of the turn-actuator is in order which would be carried out by the driven axle 5. An electrical energizing of the SMA-elements 6a, 6b can accordingly be suppressed, in order, in the most serious of cases, to avoid a directionally-opposite manual and electrical activation and to protect the SMA-elements in this way from damage.

The FIGS. 6 to 8 show an overload protective apparatus for a tensile element 6, 20. The apparatus embraces a spring element, namely a spiral compressive spring 75. By this compressive spring the force from tensile element (SMA-wires) 6, 20 is generated in an electrically energized condition, acting through the penetration of a stationary bearing point 76, which is rigidly affixed to the housing 12, that is to say, stationary in relation to the tensile element. The bearing point 76 is formed from a detent shell 79 which is affixed to the housing 12, and possesses a penetrating boring 78. In the through boring 78 is placed an electrical, non-conducting bolt 80 which has one end slidingly movable in its setting. On its other end, the bolt 80 is encircled by a set screw 82. Further, the bolt 80 is encased by the compression spring 75, whereby this spring abuts itself with its one end against the detent shell 79, that is to say, against the bearing point 76, and with its other end rests with its end face on the adjustment screw 82. With the aid of the adjustment screw 82 the prestressing of the spiral compressive spring 75 can be set. In the working end face of the adjustment screw 82 of the bolt 80, a recess 83 is available, in which an insert 84 has been threadedly attached. The insert 84 carries on its end, which protrudes from the recess 83 a protruding piece 85 which extends itself somewhat at right angles toward the bolt 80. The bolt 80, as well as the insert 84 is penetrated by a central boring, through which the tensile element 6, 20 passes. The boring 86 opens on the side of the insert 84 with a funnel-like, widened opening 87. The tensile element 6, 20 is conducted out of the opening 87 and is run on that side of the extension 85 which is remote from the bolt 80 up to its free end. At that location it is affixed in the protrusion 85 with a screwed in clamping element 88. Because of the funnel-like rounded opening 87, a sharp kink in the tensile element 6, 20 is avoided. In the area of that end of the bolt, which points away from the detent shell 79, is to be found a contact element 89, which, by means of an (not shown) electrical line is connected to a circuit which serves for the delivery of current to the tensile elements 6, 20. The extension 85, at least that area thereof which contains the opening 87 consists of electrical conducting material and acts with the contact element 89 as a counter-pole. In the case of the tensile element 6, 20 not being supplied with current, the contact element 89 and the counter contact lie in such a manner together, that the tensile element 6, 20, except for its section which extends from the opening 87 to the clamping element 88, does carry electrical current. The prestressing of the screw compression spring 75 is so adjusted, with the help of the adjusting screw 82, that it will shorten itself only by a given threshold force, which force the tensile element provides. The threshold force is so chosen, that in standard operation, for example, upon the activation of an aeration damper, the switch, which is formed by the counter-pole 90 and the contact element 89 remains shut. In the case of an overload, for example, if the mentioned aeration damper is blocked, then the force which is delivered by the tensile element overcomes the threshold force, so that the spiral compression spring 75 compresses and the switch is opened. The flow of current of the tensile element 6, 20 is then interrupted. The tensile element 6, 20 then cools itself and is again displaced by the pressure spring 756, so that the switch is once again closed.

1. A turn-actuator, comprising:
a driven element defining an axis of rotation and rotatable thereabout; and
at least a first and a second tensile element fastened to the driven element, the tensile elements each being a shape memory alloy configured to contract during a flow of electrical current therethrough, whereby respective torques generated from the first and second tensile elements on the driven element, because of contraction of the first and second tensile elements, produce opposed directions of rotation in relation to the axis of rotation.

2. A turn-actuator in accord with claim 1, wherein the directions of the first and second tensile elements, because of produced tensile forces on the driven element from contraction of the first and second tensile elements, define a common directional resultant.

3. A turn-actuator in accord with claim 2, wherein the first and the second tensile elements are placed parallel to one another and the produced tensile forces have the same direction.

4. A turn actuator in accord with claim 2, wherein the driven element is prestressed by spring force counter to the common directional resultant of the produced tensile forces which act thereon.

5. A turn-actuator in accord with claim 1, further comprising a moderating brake abutment which coacts with the driven element.

6. A turn-actuator in accord with claim 5, further comprising a third tensile element acting upon the brake abutment, the driven element, or the brake abutment and the driven element.

7. A turn-actuator in accord with claim 1, further comprising a housing, whereby the axle (4) is rigidly affixed on the housing.

8. A turn-actuator in accord with claim 1, further comprising a housing, whereby the axis of rotation defines an axial position and is movably supported in a direction perpendicular to the axial position.

9. A turn-actuator in accord with claim 8, wherein the tensile elements are disposed parallel to one another and, within the housing, the driven element being slidably supported and parallel to the tensile elements and further comprising a spring element and a moderating brake abutment, the spring element supporting itself between the driven element and the housing, the spring element being configured to prestress the driven element against the tensile forces of the tensile elements and against a the brake abutment.

10. A turn-actuator in accord with claim 1, further comprising a detent being configured to limit the angular range of the driven element.

11. A turn-actuator in accord with claim 1, further comprising a stabilizing holding element being configured to restrain the driven element to two alternative end positions.

12. A turn-actuator in accord with claim 11, wherein the holding element is a spring element which is released in the end positions but is stressed in the range between the end positions.

13. A turn-actuator in accord with claim 12, wherein the spring element is a spiral, compressive spring defining a first end and a second end, the first end on the driven element and the second end stationarily secured outside of the driven element, whereby, in a position of the driven element, between the end positions, the first and second ends of the compression spring lie in a straight line.

14. A turn-actuator in accord with claim 1, wherein at least one tensile element is bound to a spring element, by means of which the force arising from the contraction of the tensile element is introduced into a stationary bearing point opposite to the tensile element.

15. A turn-actuator in accord with claim 14, wherein the spring element is bound respectively to the end of the at least one tensile element and otherwise coacts with the bearing point.

16. A turn-actuator in accord with claim 14, further comprising a switch, which stands in such an operational relationship with the spring element that, in a case of a compression due to an overload or an expansion of the spring element, is activated thereby and the flow of electrical current to the at least one tensile element is interrupted.

17. A turn-actuator, comprising:
a driven element defining an axis of rotation and rotatable thereabout;
a plurality of shape memory alloy tensile elements connected to the driven element, the tensile elements being configured to contract to produce respective tensile forces on the driven element, each tensile force generating a torque on the driven element to produce a direction of rotation relative to the axis of rotation; and
means for contracting the tensile elements disposed proximate the tensile elements and in communication therewith.

18. The turn-actuator in accord with claim 17, wherein the means for contracting is an electrical circuit configured to supply an electrical current to the tensile elements.

19. The turn-actuator in accord with claim 17, wherein a rotational angle of the driven element is determined by a degree of contraction of at least one of the tensile elements.

20. The turn-actuator in accord with claim 17, wherein the tensile elements are in selective communication with the means for contracting.

21. The turn-actuator in accord with claim 17, wherein at least two of the tensile elements are in communication with the means for contracting, the tensile forces produced by the tensile elements being equivalent to generate opposing torques, the opposing torques producing a holding torque for positioning the driven element.

22. The turn-actuator in accord with claim 17, further comprising a connector disposed proximate the tensile elements and the means for contracting, the connector being configured to detect a foreign force acting on the driven element and to detect a resulting electrical resistance change to prevent an electrical overload.

23. A turn-actuator, comprising:
a housing;
a driven element disposed in the housing in a first position, the driven element being movable to a second position spaced apart from the first position, the driven element defining an axis of rotation in the second position and rotatable thereabout;
an electrical circuit for supplying an electrical current disposed proximate the housing;
a plurality of shape memory alloy tensile elements connected to the driven element and in communication with the electrical circuit, at least two of the tensile elements disposed parallel to one another within the housing, the tensile elements being configured to contract during a flow of the electrical current therethrough to move the driven element to the second position, the tensile elements being further configured to produce respective tensile forces on the driven element to generate respective torques on the driven element to produce respective rotations about the axis of rotation.

24. The turn-actuator in accord with claim 23, wherein the driven element is slidably supported parallel to the tensile elements and further comprising a spring element and a brake abutment, the spring element being configured to prestress the driven element to oppose the tensile forces of the tensile elements and against the brake abutment in the first position.

25. A turn-actuator, comprising:
a housing;
a driven element disposed in the housing, the driven element defining an axis of rotation and rotatable thereabout;
an electrical circuit for supplying an electrical current disposed proximate the housing;
a shape memory alloy tensile element connected to the driven element in communication with the electrical circuit, the tensile element being arranged in the housing to form at least two parallel tensile element components, the tensile element being configured to contract during a flow of the electrical current therethrough to produce a tensile force by at least one of the tensile element components to generate a torque on the driven element to produce a rotation about the axis of rotation.

26. The turn-actuator in accord with claim 25, wherein the electrical current is applied to one of the parallel tensile element components to produce the rotation in a predetermined direction.

27. The turn-actuator in accord with claim 25, further comprising a turnaround roll for guiding the parallel tensile element components.
